(19) United States
(12) Patent Application Publication
(10) Pub. No.: US 2004/0250135 A1
(43) Pub. Date: Dec. 9, 2004

(54) Method of authenticating a log-on request and related apparatus

(76) Inventors: Wassim Haddad, Verdun Municipality (CA); James Thomas Edward McDonnell, Bristol (GB)

Correspondence Address: LOWE HAUPTMAN GILMAN AND BERNER, LLP, 1700 DIAGONAL ROAD, SUITE 300 /310, ALEXANDRIA, VA, 22314, US

(21) Appl. No.: 10/811,315

(22) Filed: Mar. 29, 2004

(30) Foreign Application Priority Data
Mar. 29, 2003 (GB) 0307303.8

(51) Int. Cl. H04L 9/00

(52) U.S. Cl. 713/201; 713/176

(57) ABSTRACT

Access from a first processing apparatus to an application running on a second processing apparatus is established by sending, on behalf of the first processing apparatus, a log-on request to the second processing apparatus via a first network. There is a response to the log-on request with a demand for authentication data being sent in reply to the demand. At least one of the demand and the authentication data are sent via a second network that differs from the first network.

### FIELD OF THE INVENTION

This invention relates to a method of and related apparatus for authenticating a log-on to an application.

### BACKGROUND OF THE INVENTION

When logging onto an application running on a processing apparatus it is generally desirable to perform an authentication process to ensure that the user/machine that is trying to log-onto the application is genuine. Such an authentication tries to ensure that the application is not being accessed fraudulently. Of course, as the importance of the data that can be accessed by logging on to the application increases the desirability of providing a strong authentication increases so that it becomes harder to fraudulently access data via the application.

With the use of the Internet increasing a large amount of highly sensitive data (for example bank account details, medical records, and the like) is becoming more commonly accessible across the Internet via applications that may be connected to the Internet. As such the importance of providing robust authentication is increasing.

In prior art systems a user generally requests a log-on to the application by specifying an account that is associated with that user via a means such as a User Identity (USERID), which provides a unique identity for that account on that application. The user is then prompted for one or more passwords to verify his/her identity so that access can be granted to the application. These passwords may take the form of answers to questions which have previously been posed to the user; for example the maiden name of his/her mother; the name of their first school. Further, the password may have to meet a predetermined format that contains one or more numeric characters and/or symbols to try and increase the strength of the password (i.e., make it harder to crack).

### SUMMARY OF THE INVENTION

According to a first aspect of the invention there is provided a method of establishing access from a first processing apparatus, capable of sending and receiving data and of connecting to a first and a second network, to an application running on a second processing apparatus, capable of sending and receiving data and of connecting to the first and the second network, comprising the steps of: sending, on behalf of the first processing apparatus, data comprising a log-on request to the second processing apparatus via the first network; responding to the log-on request with a demand for authentication data to the first processing device; and replying to the demand by sending the authentication data from the first processing device, wherein at least one of the demand and the authentication data is sent via the second network, different to the first.

### BRIEF DESCRIPTION OF THE DRAWINGS

There now follows by way of example only a detailed description of the present invention with reference to the accompanying drawings in which:

FIG. 1 schematically shows a remote processing apparatus, such as a server, used in embodiments of the invention;

FIG. 2 schematically shows the communications used in embodiments of the present invention;

FIG. 3 shows a number of potential local processing apparatus that may be used to access a remote processing apparatus;

FIG. 4 schematically shows a further embodiment of the system used in relation to this invention;

FIG. 5 shows a flow chart for a first embodiment of the invention;

FIG. 6 shows a flow chart for a second embodiment of the invention; and

FIG. 7 shows a further embodiment of the invention.

### DETAILED DESCRIPTION OF THE DRAWINGS

As previously indicated, in one aspect this invention provides a method of establishing access from a first processing apparatus, capable of sending and receiving data and of connecting to a first and a second network, to an application running on a second processing apparatus, capable of sending and receiving data and of connecting to the first and the second network, comprising the steps of: sending, on behalf of the first processing apparatus, data comprising a log-on request to the second processing apparatus via the first network; responding to the log-on request with a demand for authentication data to the first processing device; and replying to the demand by sending the authentication data from the first processing device, wherein at least one of the demand and the authentication data is sent via the second network, different to the first.

The use of the second network is advantageous because it may increase the security of the method; it is unlikely, and technologically much harder, to intercept a communication that is passed via the second network. This arises because the communication sent over the second network would generally be unrelated to communications sent over the first network and as such it should be harder to intercept communications on both the first and second networks: making the method more secure than prior art methods.

It is advantageous if the second network comprises a packet switched network, because such a network provides greater flexibility in the connection between the local processing apparatus and the processing apparatus. Indeed, using a packet switched network in this manner may allow the one or both of the response to the request and the response to the response to be transmitted via a plurality of networks rather than a single network.

Using a plurality of networks may be advantageous because it adds greater flexibility to how the response to the request and the response to the response can be sent to the local processing apparatus. For example, should the local processing apparatus comprise a desktop computer it is likely that an email connection will be available, but it may perhaps be unlikely that a telephone network connection thereto will be available. Therefore, the response to the request sent to the local processing may be sent from the processing apparatus via a telephone network, perhaps via an MMS message. Since, in this example, the local processing apparatus does not have a connection to the telephone network it will not be capable of receiving this message. Therefore, the message may be directed to the service provider to which the local processing apparatus connects and is converted to an email that is then forwarded to the local processing apparatus. Therefore, this response to the response will be transmitted via two different networks: the telephone network, and the network linking the local processing apparatus to its service provider. However, the response to the response is still likely to be secure and difficult to intercept since it will have been transmitted via the telephone network for the majority of its path. It may harder to intercept a communication sent from the server of the service provider to the local processing apparatus than a communication sent across a network such as the Internet at large. It will be appreciated that an MMS message can be sent to an email address.

Generally, the request will be sent on the first network. Further, both of the demand and reply may be sent over the second network. Such an arrangement is advantageous, especially if the second network is more secure than the first, since it will be harder to intercept the data-requested to authenticate the log-on.

The term unsecure network is intended to cover networks in which data is at risk from third parties. For example, the data may be intercepted, accessed on a server without authorisation, obtained following a confidence trick (such by sending apparently valid emails requesting responses giving away account details and the like) or any other means in which the data is obtained undesirably by a third party. In particular the first, unsecure, network may comprise the Internet.

The second network may comprise a wireless telephone network. For example the second network may comprise any of the following (which is not intended to be exhaustive) a UMTS network, a GPRS network, a GSM network.

Conveniently, communications sent across the second network may comprise MMS messages. Such messages are advantageous because they may comprise data according to a plurality of different formats and as such may provide a stronger authentication than prior art systems. It is conceivable that messages sent over the second network could comprise any other format. For example the communications may comprise SMS messages. Such SMS messages are of course much shorter than MMS messages and therefore may not be capable of providing as strong an authentication as an MMS message.

The local processing apparatus may be any apparatus capable of establishing a connection (a connection over which data can be exchanged) with a processing apparatus. The skilled person will appreciate that the number of types of such apparatus is increasing and currently includes any of the following non-exhaustive list: PDA's, telephones (both mobile and fixed line), laptop computers, notebook computers, watches, desktop computers, televisions, and the like.

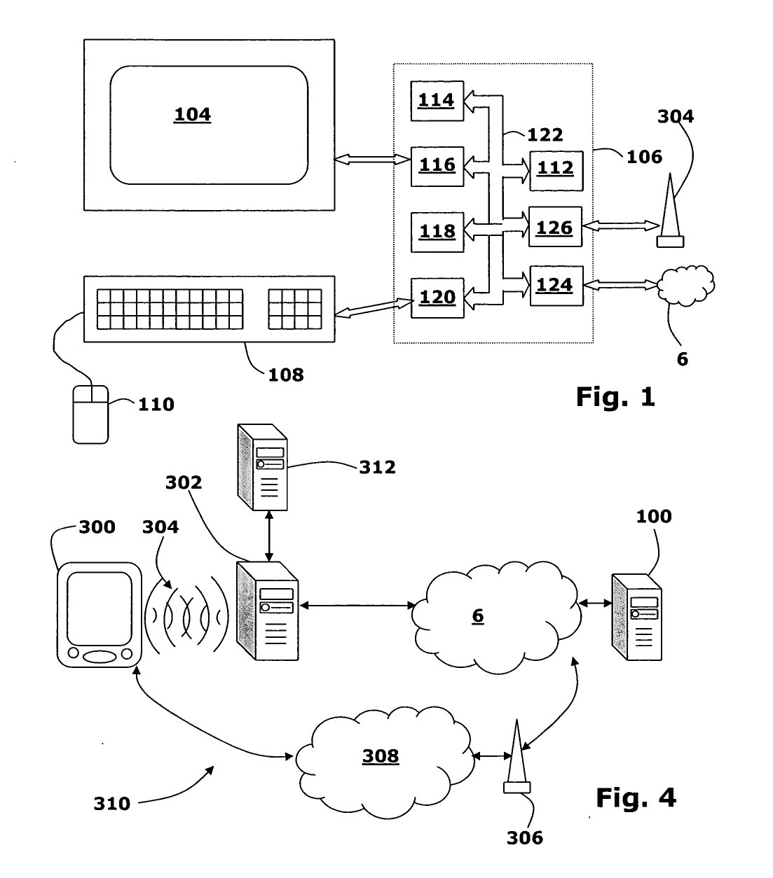

Some embodiments of this invention allow access to a remote processing apparatus across a network, although there are other aspects as discussed below. The processing apparatus may be thought of as a computing means. An example of such a processing apparatus (in this example, a server 100) is shown in FIG. 1 and comprises a display 104, processing circuitry 106, a keyboard 108, and mouse 110. The processing circuitry 106 further comprises a processing means 112, a hard drive 114, a video driver 116, memory 118 (RAM and ROM) and an I/O subsystem 120 which all communicate with one another, as is known in the art, via a system bus 122. The processing means 112 typically comprises at least one INTEL™ PENTIUM™ series processor, running at generally between 2 GHz and 2.8 GHz (although it is of course possible for other processors to be used). The remote processing apparatus may of course be any other type of computer and could for example be a mainframe computer; a mini-computer; a micro-computer; or any other suitable processing apparatus including any computer or computer system.

As is known in the art the ROM portion of the memory 118 contains the Basic Input Output System (BIOS) that controls basic hardware functionality. The RAM portion of memory 118 is a volatile memory used to hold instructions that are being executed, such as program code, etc. The hard drive 114 is used as mass storage for programs and other data.

Other devices such as CDROMS, DVD ROMS, network cards, etc. could be coupled to the system bus 122 and allow for storage of data, communication with other computers over a network, etc.

The server 100 further comprises a first transmitting/receiving means 124 which is arranged to allow the server 100 to communicate using the Internet 6 (which provides a first, unsecure, network). The first transmitting/receiving means 124 also communicates with the processing means 112 via the bus 122. A second transmitting/receiving means 126 is also provided which is capable of communicating with a second network 304, as will be described hereinafter.

Although, in this embodiment, the first and second transmitting/receiving means 124,126 connect to different networks, this need not be the case. Indeed, the first and/or second transmitting and/or receiving means may be any one of the following: a MODEM; a Network Interface Card (NIC) (whether as a separate card, or as integrated into a processing apparatus); any form of interface to a wired or wireless network; a GSM, a GPRS, a UMTS, or any other form of telephone network, connection, or the like.

The server 100 could have the architecture known as a PC, originally based on the IBM™ specification, but could equally have other architectures. The server may be an APPLE™, or may be a RISC system, and may run a variety of operating systems (perhaps HP-UX, LINUX, UNIX, MICROSOFT™ NT, AIX™, or the like)

As can be seen from FIG. 2 a local processing apparatus 300 is provided, capable of communicating with the remote processing apparatus 100 and which in this embodiment may provide a verifying means and an access requesting means. In the embodiment shown the local processing apparatus is a PDA, such as a COMPAQ iPAQ™ equipped with a UMTS connection capability and a WIFI (IEEE 802.11) connection capability, which connects the iPAQ™ 300 to a local server 302 via the wireless link 304. However, as described later the local processing apparatus could be a number of other devices. The local server 302 provides access to the Internet 6 as is known in the art.

As one of ordinary skill in the art will appreciate the Compaq™ iPAQ™ operates using the Microsoft™ PocketPC™ operating system, and runs Microsoft™ Pocket Explorer as its means of communicating with the server 100 across the Internet 6 (in conjunction with the World Wide Web). The iPAQ™ has a virtual keyboard, provided via touch screen input, and can access the web, etc. using MODEM, or network cards connected through a PC card slot, via its infrared link, or Bluetooth™ links. However, in this embodiment access to the Internet is provided by the WIFI link 304.

The iPAQ™ is also capable of receiving communications via the UMTS (sometimes referred to as 3G) connection. The UMTS connection is represented, in the Figure, by the transmitter/receiver 306 together with the cloud 308 representing the transmitted signal. Thus, the PDA 300 is capable of receiving communications from external sources using two, unrelated, communication networks. Other wireless telephony networks such as for example GPRS, GSM, connections are equally possible to connect the iPAQ™ 300.

One of ordinary skill will appreciate the existence of the MMS (Multi-media Messaging Service) protocol which is capable of transmitting messages containing data representing any form of multi-media. For example the data transmitted by an MMS message may represent graphics, audio samples, images, video clips, streamed data, allow synchronised presentations to take place and the like. Indeed, the initial specification of MMS has been defined to work with the following data-formats:

1. image: JPEG, GIF 89a, WBMP

2. video: ITU-T, H.263, MPEG 4 simple profile

3. audio: MP3, MIDI, WAV, AMR/EFR-for voice.

This embodiment provides a method of logging on to a network, remote application, remote computer, a processing apparatus or any other similar circumstances and will be described, in this embodiment, in relation to logging on to an application running on the server 100. Generally, even when logging onto an apparatus it is software (i.e., an application) that handles the log-on process rather than hardware.

As one of ordinary skill in the art will appreciate the iPAQ™ 300 will already have a connection 304 to the local server 302 (which may also be established using the teachings of this invention) to allow access to the Internet 6.

The iPAQ™ 300 can also communicate with the remote apparatus, or server 100, via a UMTS based communication via the transmitter/receiver 306, which provides the UMTS cell 308 with which the iPAQ™ 300 communicates, which together provide a UMTS connection 310. The use of MMS messages across the UMTS connection 310 may be particularly convenient for embodiments described herein.

The server 100 can be accessed across the Internet 6 by the iPAQ™ 300 by a user of the iPAQ™ 300 entering the appropriate URL to specify the remote apparatus (the remote server 100). Data packets will then be routed across the Internet 6 and delivered to the remote server 100. Before access is granted to the remote server 100, the identity of the iPAQ™ 300/user thereof should be established and this is achieved using an authentication process.

Historically, such authentication has relied on assigning a password to a user identity (USERID) that a local apparatus such as the iPAQT™ 300 supplies in order to gain access to the remote server 100. The access granted to the iPAQ™ 300 will be determined by the privileges granted to that particular USERID.

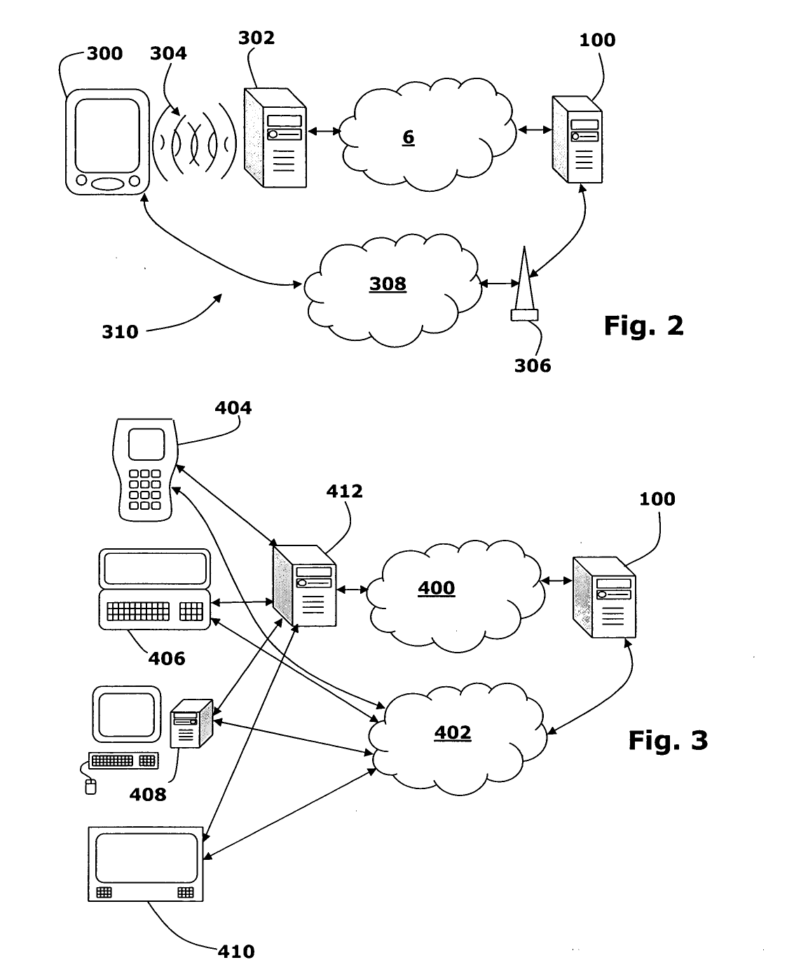

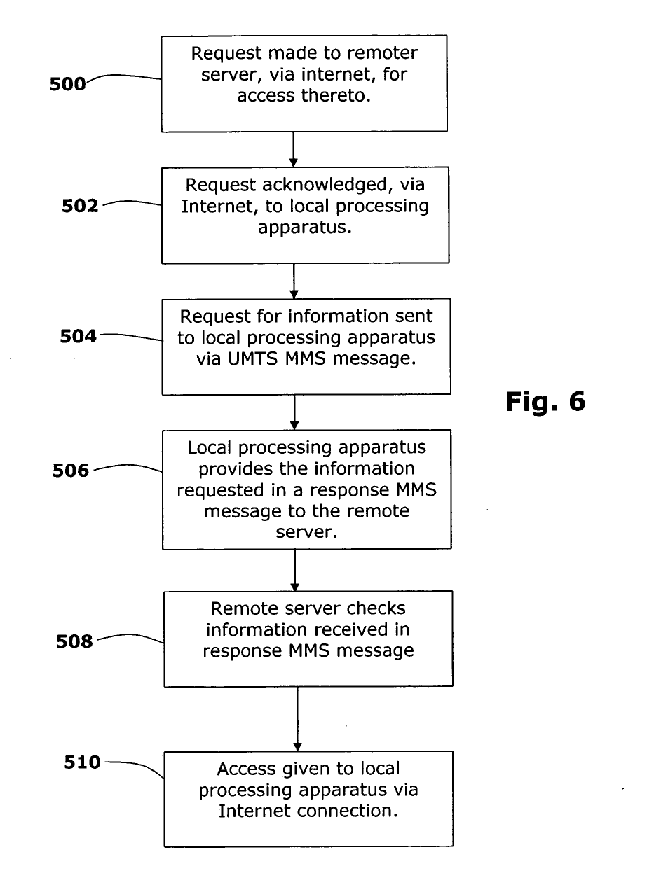

In the embodiment being described in relation to FIGS. 3 and 6 authentication relies a communication across the UMTS connection 310 and proceeds as follows: the user of the iPAQ™ 300 enters the URL of the remote server 100 and makes a request to log-on to a predetermined account defined by a USERID 500. This log-on request may be thought of as an access request made by an access requesting means. Data packets containing the request to log-on to the account are routed to the remote server 100, which is running the application to which it is desired to log-on to. The server 100 acknowledges 502 the data packets across the Internet 6 and specifies that an MMS message will be sent to the iPAQT™ 300 via the UMTS connection 310.

The remote server 100 then generates the MMS message and sends 504 it across the UMTS connection 310. As will be described herein after the MMS message can contain many different mechanisms for identifying the identity of the iPAQT™ 300/user thereof. This MMS message may be thought of as a demand for authentication data, since it will contain a request for such data.

Once the iPAQ™ 300 receives the MMS message (demand for authentication data), the iPAQ™ 300/user thereof sends 506 data that has been requested by the remote server 100 in its MMS message to the iPAQ™ 300 in a reply to the demand via an MMS message back to the remote server 100 using the UMTS connection 310. For example, in this embodiment the response MMS message from the remote server 100 asks for a signature of the user to be provided. The user therefore signs the screen of the iPAQ™ 300 so that this can be returned to the remote server 100.

The remoter server 100 receives the reply MMS message, which includes the signature of the user, from the iPAQ™ 300 and checks 508 that information contained therein does indeed verify the identity of the iPAQ™ 300/user thereof; i.e., the information contained in the MMS message is correct. If the information contained in the MMS message is correct then the authentication is complete and the iPAQ™ 300/user thereof is allowed access 510 to the account that it/he/she was trying to access.

The accuracy of the information contained in the reply MMS message is checked using known techniques for verifying that particular format of data item. For example a known signature checking algorithm is used to check the validity of a signature against a pre-stored signature for that particular user.

In some embodiments the user is asked to attach a predetermined data item rather than being asked to create a new data item. For example, the user may be asked to return one of a plurality of data items that are stored in a memory to which the local processing apparatus has access. In such embodiments it may be a requirement that the data item returned in the response message is identical to the one requested by the remote server 100.

As discussed above, the MMS message can contain a large number of different data types/formats. It is therefore, possible for the remote server 100 to request from the iPAQ™ 300/user thereof a specified data item. For example, the remote server 100 may specify that the iPAQ™ 300/user thereof should send a specified video clip, sound clip, picture, signature, finger print, or the like. Any of these clips may be provided as a file.

The data sent in the MMS message could be hashed using known hashing techniques, which may increase the security of the communication further. For example, the MMS may include a picture which has been hashed using a known algorithm using a private key as the seed of that algorithm. The picture may then be unhashed using a public key corresponding to the private key used to hash the picture. Such hashing may be thought of as securing the file in which the information is held.

The length of the key may be tailored to the device to which it is being sent. It will be appreciated from FIG. 3 that messages could be sent to/received from a variety of different devices. The processing power of these devices is likely to vary from one to another and devices having a lower processing power may not be able to process long keys.

The data item may be maintained in a memory accessible to the iPAQ™ 300/user thereof, or alternatively and perhaps more preferably may be created by the iPAQ™ 300/user thereof in order to send the response MMS message. For example, the user of the iPAQ™ 300 may sign the screen of the device to generate a data item comprising a signature that is sent in the response message to the remoter server 100.

In likewise manners sound input means (generally a microphone, or the like) of the iPAQ™ 300 may be used to record a sound clip (for example, the user speaking) in order to verify the identity of the user.

It will be appreciated that mobile telephones exist that allow a user to take a picture and/or a video clip as a data item and subsequently transmit that data item via an MMS message. Similarly, the remote server 100 could request in the MMS message to the iPAQ™ 300 that a video clip/picture of a predetermined object. It would also be possible for other devices to generate/capture pictures and/or video clips.

In some embodiments the predetermined object may be something that determines the location of the iPAQ™ 300/user thereof. Such an arrangement may be useful in situations in which the location of the user is to be used to provide location based services, or may be useful to provide an authentication if the location of the iPAQ™ 300/user thereof is known. It is known to fit GPRS modules to mobile devices such as an iPAQ™ 300, which may be used to provide location information.

In this embodiment, and as represented by FIG. 3, the local device 300 need not be a PDA and could be any form of device capable for communicating with the remote server 100 via a first network 400 and a second network 402. A possible list of such devices, which is not intended to be exhaustive, includes: a telephone (show as a mobile telephone in the Figure, but not necessarily so) 404; a notebook computer and/or PDA with keyboard 406; a computer such as a PC, apple, or the like 408; a television 410. Generally, and as represented in the Figure such devices may connect through a local server 412 in order that access is provided to one or more of the networks, such as the Internet 6, and in the Figure access is provided to the first network via the local server 412.

The system may be arranged such that the iPAQ™ 300 is arranged to periodically send an MMS message via the UMTS connection 310 to re-authenticate the log-on to the application running on the remote server 100. Such an arrangement can help to keep the connection secure and may help identify situations in which the connection has been compromised by a third party.

The system shown in FIG. 2 may comprise a RADIUS (Remote Authentication for Dial in User Service) server and such an arrangement may as seen if FIG. 4. It will be appreciated that a RADIUS server is a sub set of an Authentication Authorisation Accounting (AAA) server, which are likely to become more common as wireless telephone networks migrate to 3G technology. As can be seen from FIG. 4 the server 302 to which the iPAQT™ 300 connects may be an AAA server and this server may connect to an authentication server 312. It will be appreciated that there are many other possible network topologies that may be used.

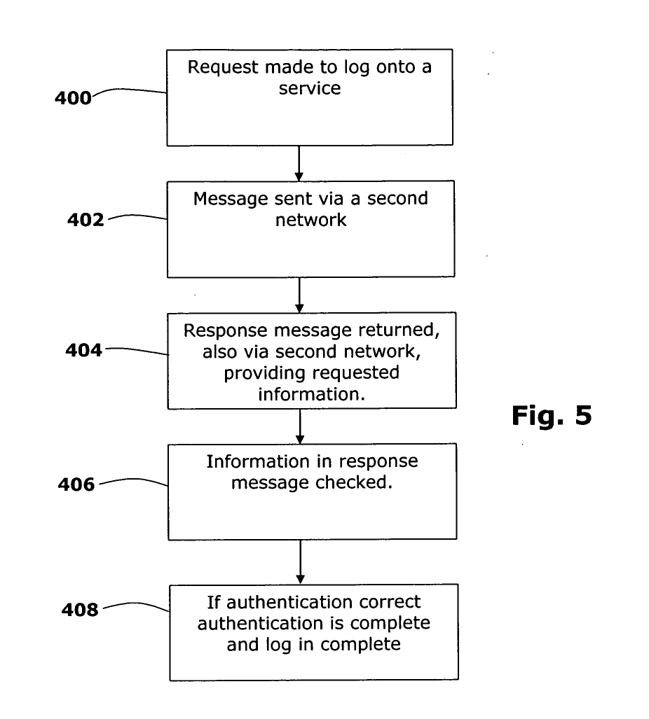

A flow chart for the process described above can be seen in FIG. 5 in which a log-on request has been made to log-on to a service is made 400. In response to this request to log-on to the service, a demand for authentication data is sent via a second network, in particular but not exclusively, as an MMS message 402. This demand contains a request for predetermined authentication data that is intended to provide a “strong” authentication of the user's/machine's identity that is making the request. A reply is returned to the demand containing the data that was requested in the demand for data 404. The correctness of the information returned in the reply is checked 406 and if the information is correct then the log-on is complete following a successful authentication of the user's/machine's identity 408.

Although the above embodiments describe the second network as comprising a UMTS connection it could of course be any network capable of connecting the remote and local processing apparatus. It is convenient if the second network is a wireless network such as UMTS, GPRS, or the like, since this may increase the security of the messages. However, this need not be the case. It is known for users to hold accounts with different Internet Service Providers (ISP's) and some embodiments of the invention may send the request and response messages across the same infrastructure (e.g., the Internet), but using a different ISP and so provide two different networks.

Further, it will be appreciated that the above embodiments talk about a first and a second network. It would of course be possible to for a communication (whether a log-on request, a demand, or a reply) to be sent via a plurality of different networks. For example, the demand for authentication data may be sent to via a MMS message which is subsequently converted into an email for a portion of its journey. The skilled person will appreciate that an MMS message can be sent to an email address.

At least some of the advantages of the invention may be provided by the provision of a network connection which includes, or is predominately, a wireless connection, and in particular a wireless telephone connection. Further, the message may exist in another format before being converted into an MMS, or other format, for transmission.

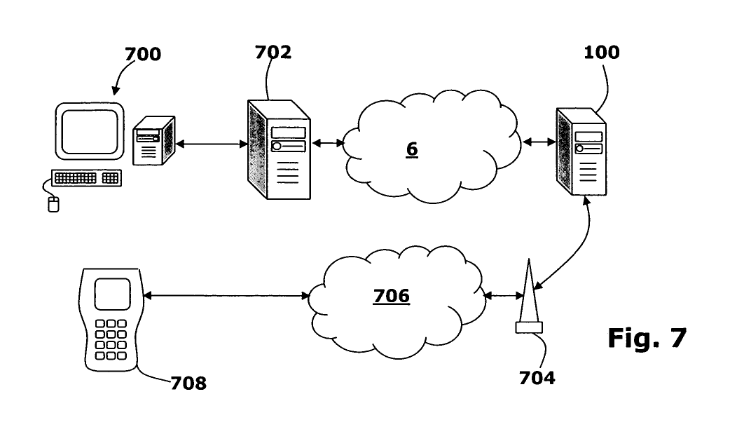

In a broad aspect the invention may be considered as using a communication over a second network to authenticate a log-on over a first network. Or indeed, similar methods may be applicable to allow a user to directly login to a processing apparatus (i.e., not over a network connection) and such an arrangement is shown in FIG. 7. In such embodiments once a login request has been made to the processing apparatus a communication is subsequently sent over a network to verify the identity of the user much in the same way as the communication is sent over the at least one second network in the above described embodiments. It will be seen that (and unlike in the embodiments described to date) that the access requesting means and the verifying means are provided by different devices in the embodiment described in relation to FIG. 7.

For example, a user attempting to log-on to an application running on a computer 700 providing an access requesting means, or other processing apparatus, by making an access request thereto may be sent a demand for authentication data to a device 708 separate to the computer 700 running the application on to which he/she is trying to log. The device 708 separate to the computer may be thought of as a proxy which is used to authenticate the log-on request.

In a specific example, a user may try and log-on to an application running on a PC 700. The PC 700 may cause a message, which may be an MMS message, to be sent to his/her mobile phone 708 demanding authentication data and as such, the mobile telephone 708 may provide a verifying means. The user may then respond to the MMS message either by replying on his/her telephone 708, or by inputting his/her reply onto the PC 700 in order to validate his/her log-in.

For the avoidance of doubt, in this embodiment the PC 700 connects to a local server 702 (which may be an AAA server) in order to access the Internet 6 and consequently gain access to a remote server 100. The remote server 100 is capable of generating an MMS (or other message) via a transmitter 704 and a communication medium 706 to the telephone 708. It will be appreciated that the PC 700 could communicate with a remote server 100 with a medium other than the Internet 6 and could for instance send a communication such as an MMS message. The invention may be thought of as using an MMS message to authenticate a request to log-on to an application.

The access requesting means may be any processing apparatus capable of having an access request made thereto. Further, the verifying means may be any processing apparatus capable of verifying a log-on request. The access requesting means and the verifying means may be provided by different processing apparatus, or maybe by the same apparatus. Possible examples of access requesting means and/or a verifying means include any of the following: a computer (whether desktop, laptop, handheld, server, etc.), a PDA, a telephone, a television, a watch, or any other device capable of communicating over a network.

Method steps carried out by computing entities involved in aspects of the invention may be carried out by suitably programmed devices, and in aspects the invention provides for computer readable media containing code adapted to program such devices accordingly. Such a computer readable medium may comprise any of the following: a floppy disk, a hard drive, a CD ROM (including RW), a DVD ROM/RAM (including +RW/−RW), any form of magneto/optical storage, magnetic tape, memory, a transmitted signal (including an Internet file transfer, ftp, or the like), a wire, or any other suitable medium.

What we claim is:

1. A method of establishing access from a first processing apparatus, capable of sending and receiving data and of connecting to a first and a second network, to an application running on a second processing apparatus, capable of sending and receiving data and of connecting to the first and the second network, comprising the steps of: sending, on behalf of the first processing apparatus, data comprising a log-on request to the second processing apparatus via the first network; responding to the log-on request with a demand for authentication data to the first processing device; and replying to the demand by sending the authentication data from the first processing device, wherein at least one of the demand and the authentication data is sent via the second network, different to the first.

2. A method according to claim 1 in which the demand and the authentication data is sent via the second network.

3. A method according to claim 1 in which the demand and/or the authentication data are sent as an MMS message.

4. A method according to claim 3 in which the MMS message requests or provides a file containing predetermined information.

5. A method according to claim 4 in which data provided by the file is hashed.

6. A method according to claim 1 in which the first processing apparatus periodically sends a message via the second network re-authenticating the log-on to the application.

7. A method according to claim 1 in which the second processing apparatus is a server.

8. A method according to claim 1 wherein the first and second networks differ by virtue of a lack of identity in regard to at least one characteristic selected from the group consisting of:
commercial control of access to a least part thereof;
at least one communication protocol employed therein;
transmission medium for data over at least a part thereof; and
intrinsically available frequency bandwidth for transmission of data over at least part thereof.

9. A system comprising at least a first processing apparatus which is capable of being connected, by a first network and a second network connection, to at least one second processing apparatus running an application to which access is gained from the first processing apparatus, the system being arranged to allow the first processing apparatus to initiate a log-on to the application by sending a log on request to the application on the second processing apparatus, the second processing apparatus being arranged to generate a demand for authentication data in response to the request and transmit the demand to the first processing apparatus and the first processing apparatus being arranged to transmit a reply to the demand including the authentication data to the second apparatus, the system being arranged such that at least one of the log-on request, the demand and the reply to the demand is sent via the second network.

10. A processing apparatus for running an application onto which users can log-on and comprising a first transmitting means and a first receiving means arranged respectively to transmit and receive data across a first network, a second transmitting means and a second receiving means arranged respectively to transmit and receive data across a second network, different from the first network, and a processing means, at least one of the receiving means being arranged to receive a request to log-on to the application and pass the request to the processing means, the processing means being arranged to cause at least one of the transmitting means to transmit a demand for authentication data and at least one of the receiving means being arranged to receive a reply to the demand which is arranged to forward the reply to the processing means which is arranged to determine whether the authentication data has been supplied in the reply and to authenticate the log-on request accordingly, wherein at least one of the request, the demand and the response is sent using the second network.

11. An apparatus according to claim 10 in which the first transmitting means and first receiving means are arranged to communicate with the Internet.

12. An apparatus according to claim 10 in which the second transmitting means and the second receiving means are arranged to communicate with a wireless telecommunication network.

13. An apparatus according to claims 10 in which at least one of the demand and the reply are arranged to be sent as an MMS message.

14. A method of establishing access from a first processing apparatus to an application running on a second processing apparatus, the second apparatus being capable of being connected to a first network and a second network, the method comprising receiving a request to log-on to the application from at least one of the first and second networks, sending a demand for authentication data via at least one of the first and second networks and receiving a reply to the demand including the authentication data, via at least one of the first and second networks, and processing the authentication data to determine whether it is the demanded authentication data and authenticating the log-on request accordingly, wherein at least one of the request, the demand, and the reply is transmitted using the second network.

15. A processing apparatus arranged to generate a request to initiate a log-on with an application capable of being connected thereto via at least a first and a second network wherein the apparatus is arranged to generate a log-on request and transmit the request across at least one of the first and second networks, further arranged to receive a demand for authentication data in response to the request from at least one of the first and second networks, further arranged to process the demand and to generate a reply thereto including the authentication data and further arranged to send the reply across at least one of the first and second networks, wherein the apparatus is arranged such that at least one of the request, the demand, and the reply is transmitted using the second network.

16. A method of establishing access to an application running on a processing apparatus from a first processing apparatus and capable of being connected to the application by a first network and a second network comprising generating a request to log-on to the application and transmitting the request across at least one of the networks; receiving a demand for authentication data in response to the request from at least one of the first and second networks; generating a reply to the demand including the authentication data and sending the reply across at least one of the first and second networks, wherein at least one of the request, the demand and the reply is transmitted using the second network.

17. A computer readable medium including instructions which, when read onto a computer, cause said computer to perform the method of claim 1.

18. A computer readable medium including instructions which, when read onto a computer, cause said computer to perform the method of claim 14.

19. A computer readable medium including instructions which, when read onto a computer, cause said computer to perform the method of claim 16.

20. A computer readable medium including instructions which, when read onto a computer, cause said computer to function as the processing apparatus of claim 9.

21. A computer readable medium including instructions which, when read onto a computer, cause said computer to function as the processing apparatus of claim 10.

22. A computer readable medium including instructions which when, read onto a computer, cause said computer to function as the processing apparatus of claim 15.

23. A method of making a connection from a computing device, capable of sending and receiving data and of connecting to a first and a second network, to an application running on a further computing device, capable of sending and receiving data and of connecting to the first and the second network, comprising the steps of: sending, on behalf of the computing device, data comprising a log-on request to the further computing device via the first network; responding to the log-on request with a demand for authentication data; and replying to the demand by sending the authentication data, wherein at least one of the demand and the authentication data are sent via the second network, different to the first.

24. A processing apparatus for running an application onto which users can log-on and comprising a first transmitting means and a first receiving means arranged respectively to transmit and receive data across the Internet, a second transmitting means and a second receiving means arranged respectively to transmit and receive data across a wireless telecommunication network, and a processing means, at least one of the receiving means being arranged to receive a request to log-on to the application and pass the request to the processing means, the processing means being arranged to cause at least one of the transmitting means to transmit a demand for authentication data and at least one of the receiving means being arranged to receive a reply to the demand which is arranged to forward the reply to the processing means which is arranged to determine whether the authentication data has been supplied in the reply and to authenticate the log-on request accordingly, wherein at least one of the request, the demand and the response is adapted to be sent using the wireless telecommunication network.

25. A processing apparatus according to claim 24 in which at least one of the request, the demand and the response are sent as an MMS message.

26. A processing apparatus for running an application onto which users can log-on and comprising a first transmitter and a first receiver arranged respectively to transmit and receive data across a first network, a second transmitter and a second receiver arranged respectively to transmit and receive data across a second network, different from the first network, and a processor, at least one of the receivers being arranged to receive a request to log-on to the application and pass the request to the processor, the processor being arranged to cause at least one of the transmitters to transmit a demand for authentication data and at least one of the receivers being arranged to receive a reply to the demand which is arranged to forward the reply to the processor which is arranged to determine whether the authentication data has been supplied in the reply and to authenticate the log-on request accordingly, wherein at least one of the request, the demand and the response is adapted to be sent using the second network.

27. A processing apparatus for running an application onto which users can log-on and comprising a first transmitter and a first receiver arranged respectively to transmit and receive data across the Internet, a second transmitter and a second receiver arranged respectively to transmit and receive data across a wireless telecommunication network, and a processor, at least one of the receiver being arranged to receive a request to log-on to the application and pass the request to the processor, the processor being arranged to cause at least one of the transmitter to transmit a demand for authentication data and at least one of the receiver being arranged to receive a reply to the demand which is arranged to forward the reply to the processor which is arranged to determine whether the authentication data has been supplied in the reply and to authenticate the log-on request accordingly, wherein at least one of the request, the demand and the response is adapted to be sent using the wireless telecommunication network.
